(19) United States
(12) Patent Application Publication
(10) Pub. No.: US 2007/0175879 A1
(43) Pub. Date: Aug. 2, 2007

(54) Floor heating system

(76) Inventor: Thaddeus M. Jones, Bremen, IN (US)

Correspondence Address: TAYLOR & AUST, P.C., 142 SOUTH MAIN STREET, P. O. BOX 560, AVILLA, IN, 46710, US

(21) Appl. No.: 11/372,289

(22) Filed: Mar. 9, 2006

Related U.S. Application Data
(63) Continuation-in-part of application No. 11/343,782, filed on Jan. 31, 2006.

(51) Int. Cl. H05B 3/00

(52) U.S. Cl. 219/213

(57) ABSTRACT

A floor heating system including a sub-floor, a plurality of fasteners, at least one resistive conductor and a capacitor. The at least one resistive conductor is fastened to the sub-floor by way of the plurality of fasteners. The capacitor is electrically in series with the at least one resistive conductor.

### CROSS REFERENCE TO RELATED APPLICATIONS

This is a continuation-in-part of U.S. patent application Ser. No. 11/343,782, entitled “FLOOR HEATING SYSTEM”, filed Jan. 31, 2006.

### BACKGROUND OF THE INVENTION

1. Field of the Invention

The present invention relates to a floor heating system, and, more particularly, to an electrical floor heating system.

2. Description of the Related Art

Under floor heating systems date back thousands of years including Roman and Korean heating system where stone slabs are installed on an upper part of flues in a hypocaust connected with a fuel feeding port and a chimney. A burning fuel, such as wood or coal is burnt thereby heating the floor from the underneath side. The problem with this system is that a lot of thermal energy is drawn off by way of the fuel feeding hole and the chimney when a fire is not kindled therein. Some modem floor heating systems include the circulation of a heated thermal medium fluid through long, thin seamless pipes disposed beneath a floor. A floor heating system that involves the circulation of a thermal medium fluid has a portion of a floor that is heated to a higher temperature than a portion of the floor associated with the end of the circulation path. For example, the temperature of the heated thermal medium as it circulates gradually decreases in temperature causing the portion that is first heated to be heated to a higher temperature than the area of the floor associated with the end of the circulation path.

The installation of electrical heating wires disposed in or beneath the floor have to be selected for their resistivity, which will result in a proper resistance load for the power system. In order to provide an adequate selection of resistivities a large stock of heating wires are required to provide an adequate power density and yet still meet the power constraints of the power source. A problem with this approach is that a significant number of resistive wires must be inventoried to meet a range of floor areas.

Typical systems for the heating of a floor using a single heating cable, which is a current practice requires fifteen different cables depending upon the square footage in a range of 15 to 180 square feet of floor area, when using 120 volt power to supply a heat flux of no more than 8 Watts per square foot. As shown in the following table:

| FLOOR AREA sq ft | WATTS |
|---|---|
| 15 | 120 |
| 24 | 192 |
| 29 | 228 |
| 38 | 300 |
| 48 | 384 |
| 62 | 492 |
| 70 | 564 |
| 84 | 672 |
| 93 | 744 |
| 105 | 840 |
| 120 | 960 |
| 132 | 1056 |
| 150 | 1200 |
| 165 | 1320 |
| 180 | 1440 |

Additionally if 240 volts is considered there is a requirement for seven additional resistance heating cables to cover the range from 30 to 168 square feet. The combination of which would require the manufacture to stock twenty-two different heater cable resistance values resulting in an uneconomic inventory and ordering situation. It is uneconomic to purchase or manufacture resistance wires in quantities of less than 50,0000 feet of each type. This would require stocking up to 1.1 million feet of cable to accommodate the voltage and floor area variations.

What is needed in the art is a method of providing an under floor heating wiring that will reduce the required inventory to not exceed the maximum power density for heating the floor.

### SUMMARY OF THE INVENTION

The present invention provides a multi-segment heater for use in a floor heating system.

The invention comprises, in one form thereof, a floor heating system including a sub-floor, a plurality of fasteners, at least one resistive conductor and a capacitor. The at least one resistive conductor is fastened to the sub-floor by way of the plurality of fasteners. The capacitor is electrically in series with the at least one resistive conductor.

An advantage of the present invention is that the heating system reduces the number of different resistivity wires that must be stocked to meet the power density required for heating a range of floor areas.

Another advantage of the present invention is that the segments can be easily butt spliced together.

Yet another advantage of the present invention is that the selective inclusion of the capacitor allows for greater flexibility in the selection of resistive conductors.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a representative view of an embodiment of a floor heating system of the present invention;

FIG. 2 is a schematic representation of lengths of resistive conductors utilized in the floor heating system of FIG. 1;

FIG. 3 illustrates a termination of an end of a resistive conductor utilized in FIGS. 1 and 2;

FIG. 4 illustrates fastening of a heating conductor utilized in FIGS. 1-3;

FIG. 5 is a cross-sectional view of the heating cable taken along line 5-5 of FIG. 3;

FIG. 6 illustrates a method of splicing ends of the heating cable illustrated in FIGS. 1-5;

FIG. 7 is a schematic representation of a power reduction circuit utilized in the present invention; and

FIG. 8 is another embodiment of a power reduction circuit of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

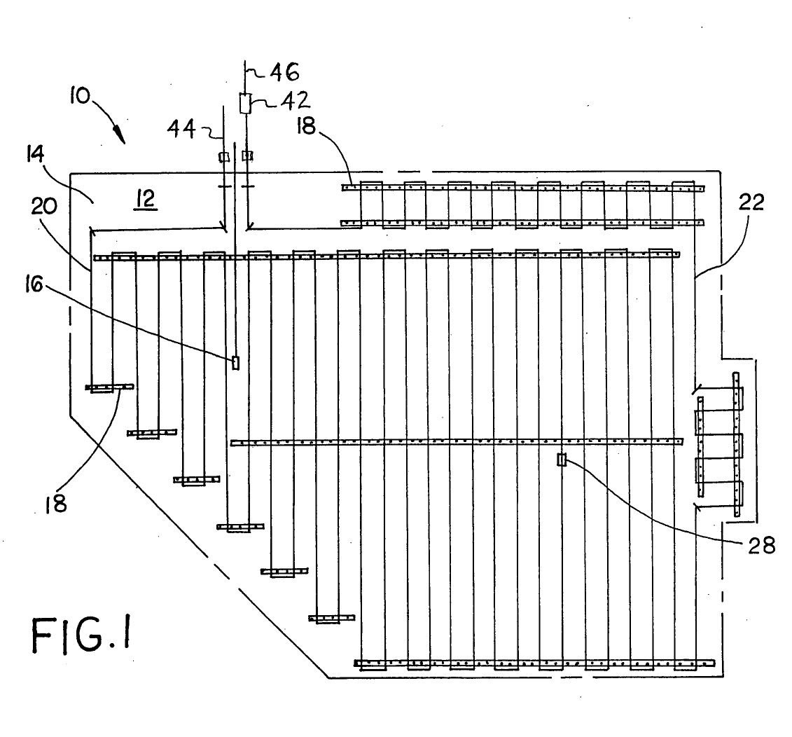

Referring now to the drawings, and more particularly to FIG. 1, there is shown a floor heating system 10 installed upon a floor 12. Floor 12 has a surface area 14, which is utilized in the calculation of the resistivity of the heating conductors as well as the lengths of the heating conductors. Floor heating system 10 includes a temperature sensor 16, fasteners 18, a first resistive conductor assembly 20 and a second resistive conductor assembly 22. Floor 12 is a base floor, which may underlie a finished floor in an area in which a heated floor such as a ceramic floor is desirable. Onto floor 12 there is attached fasteners 18, which may be in the form of clips 18 to which first resistive conductor assembly and second resistive conductor assembly 22 is attached. The use of two resistive conductor assemblies in this illustration is illustrative of the current method and more than two resistive conductor assemblies may be utilized in this invention. Temperature sensor 16 is connected to a controller that detects the temperature of floor 12 and regulates the duration and/or current supplied to resistive conductor assemblies 20 and 22. Resistive conductor assemblies 20 and 22 are laid out in a pattern so as to uniformly distribute heat to floor 12. The layout of resistive conductor assemblies 20 and 22 may be in a serpentine manner and may be separated into smaller serpentine patterns. A splice 28 connects first resistive conductor assembly 20 to second resistive conductor assembly 22.

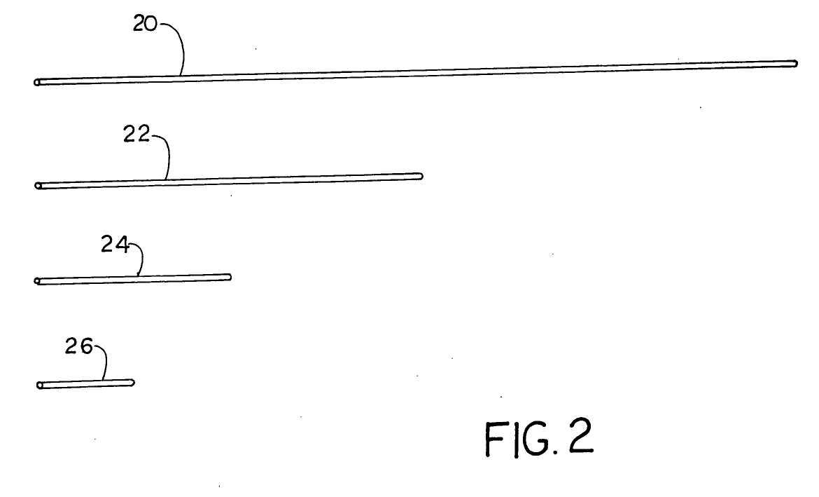

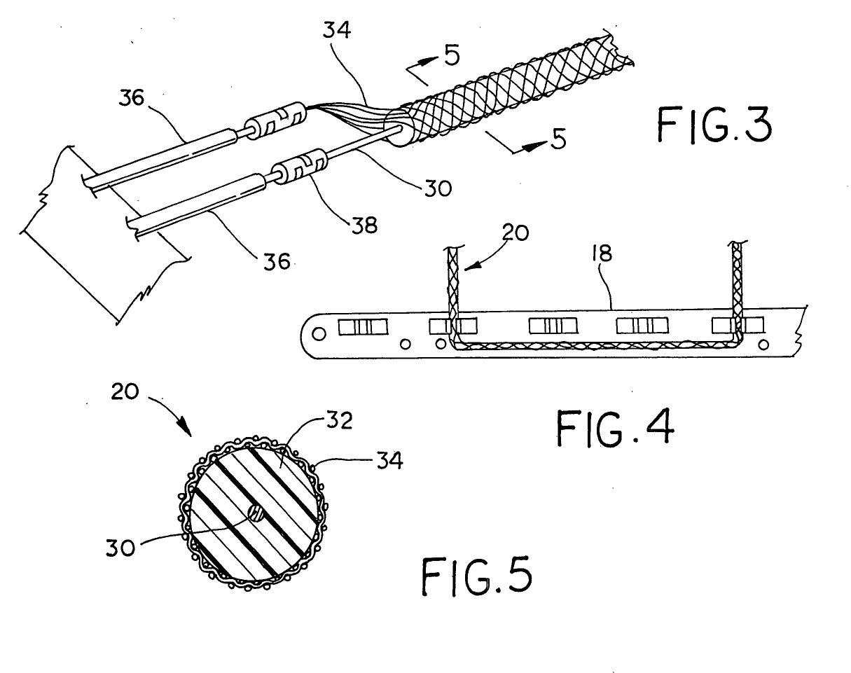

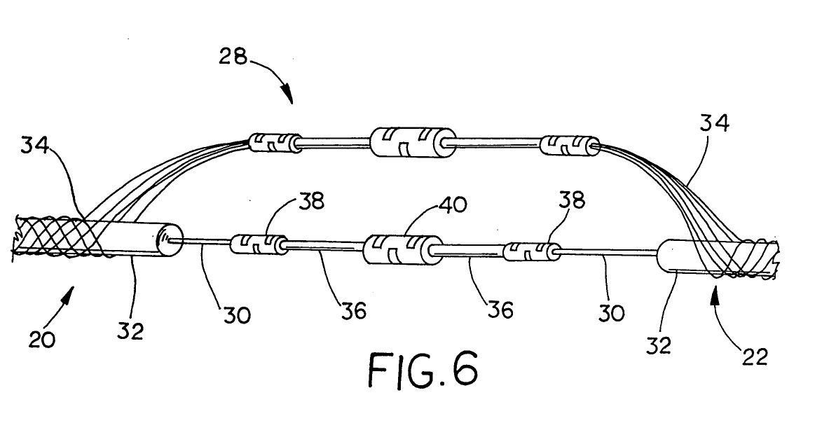

Now, additionally referring to FIGS. 2-6, and more particularly to FIG. 2 there is shown resistive conductor assemblies 20, 22, 24 and 26. FIG. 2 illustrates four lengths, with resistive conductor assembly 20 being the longest and resistive conductor assembly 22 being half of the length of resistive conductor assembly 20. In a like manner, resistive conductor assembly 24 is half of the length of resistive conductor assembly 22 and one-fourth the length of resistive conductor assembly 20. Likewise, resistive conductor assembly 26 is half of the length of resistive conductor assembly 24, one-fourth the length of resistive conductor assembly 22, and one-eighth the length of resistive conductor 20. There exists a substantial doubling in length from resistive conductor assembly 26 to each preceding conductor assembly. The relationship of the lengths of each resistive conductor assembly is utilized in the present invention to reduce the quantities of resistive conductors that are necessary to be inventoried by a supplier. Each resistive conductor assembly 20, 22, 24 and 26 includes a resistive wire 30 surrounded by electrical insulation 32 and an outer shield 34, which may be of a woven wire configuration. Connected to resistive wire 30 is a cold conductor 36 that is connected thereto by way of a cold end splice 38. If two resistive conductor assemblies are being joined together, cold conductors 36 are connected by way of a butt splice 40. The cold end splices simplify the installation by allowing a less skilled installation person to perform the necessary crimping of a cold conductor. Typically a cold end splice of an end of a resistive conductor to a cold conductor 36 involves splicing an eighteen gauge wire 36 to a solid copper-nickel alloy heater wire 30 in the range of 20 to 30 gauge. This requires special training that is not available to a typical installation person. The splicing of resistive wire 30 to cold conductor 36 has to be properly done so as to not create potential hot spots, which may cause the electrical connection to fail. A butt splice 40 of two cold conductors 36 can be done without the potential of the problems that can be encountered with the splicing of the copper-nickel alloy resistive wire 30 to cold conductor 36. This technique of having pre-applied cold conductors 36 to resistive wires 30 allows for easy installation by less skilled individuals.

In the current art many different resistances of heater wire have to be stocked, often over twenty, in order to have sufficient values of total resistance of a single wire to provide an adequate power density to the floor, while not being too low of a resistance for the length to avoid overdrawing the power source and tripping a circuit breaker. Wire manufacturers charge premium prices for wire purchased in lengths of less than 100,000 feet, so there is an advantage to purchasing fewer types of resistivity wire. The present invention teaches a method of spanning variable floor area of a factor of eight with only three wire resistances. This constitutes an area range of approximately 8:1 with only three required resistances.

The present invention involves a binary scheme. Each of the three wire resistivities span a 2:1 floor area range, based on a tolerance of power density that can be reasonably imparted to floor 12, by way of a controller. Next, within any area range, resistive conductor assemblies 20, 22, 24 and 26 can be selected for the individual lengths, thereby spanning potentially significant variations in area. For example, assuming that resistive conductor assembly 20 has a length of 200 feet; then resistive conductor assembly 22 has a length of 100 feet; resistive conductor assembly 24 has a length of 50 feet; and resistive conductor assembly 26 has a length of 25 feet. For a floor area 12 that requires two conductor assemblies, such as that illustrated in FIG. 1, conductor assembly 20 and 22 may be selected to meet the need for area 14. Adding different combinations of the lengths of resistive conductor assemblies 20-26 illustrate how they can produce a significant number of variable lengths of resistive conductor assemblies 20-26.

To further illustrate the potential range of areas that can be heated at a substantially similar heat density, the following tables illustrate a range from 13 square feet to 100 square feet that is covered with three resistivities of wire. Each installation kit has a single resistivity of wire with four resistive conductor assemblies of lengths as described herein.

TABLE No. 1

| | |
|---|---|
| Max heated area = | 100 (feet²) |
| Min heated area = | 50 (feet²) |
| Line voltage = | 120 (volts) |
| Line current = | 6.7 (amps) |
| Heater power = | 800 (watts) |
| Max heater length = | 375 (feet) |
| Heater ohms/k-ft = | 45 (ohms per 1000 feet) |

In the tables that follows:
L0 = Base heater wire length (feet)
L1 = First selectable heater wire length (feet)
L2 = Second selectable heater wire length (feet)
L3 = Third selectable heater wire length (feet)
TOT = Total heater wire length (feet)
OHMS = Resistance of total heater wire length (ohms)
WATTS = Total power dissipated by the heater wire (watts)
AMPS = Heater current (amps)
AREA = Heated floor area (feet²)

WIRE LENGTHS (FEET)

| L0 | L1 | L3 | L4 | TOT | OHMS | WATTS | AMPS | AREA |
|---|---|---|---|---|---|---|---|---|
| 200 | 0 | 0 | 0 | 200 | 9.0 | 1600 | 13.3 | 50 |
| 200 | 0 | 0 | 25 | 225 | 10.1 | 1422 | 11.9 | 56 |
| 200 | 0 | 50 | 0 | 250 | 11.3 | 1280 | 10.7 | 63 |
| 200 | 0 | 50 | 25 | 275 | 12.4 | 1164 | 9.7 | 69 |
| 200 | 100 | 0 | 0 | 300 | 13.5 | 1067 | 8.9 | 75 |
| 200 | 100 | 0 | 25 | 325 | 14.6 | 985 | 8.2 | 81 |
| 200 | 100 | 50 | 0 | 350 | 15.8 | 914 | 7.6 | 88 |
| 200 | 100 | 50 | 25 | 375 | 16.9 | 853 | 7.1 | 94 |

TABLE No. 2

| | |
|---|---|
| Max heated area = | 50 (feet²) |
| Min heated area = | 25 (feet²) |
| Line voltage = | 120 (volts) |
| Line current = | 3.3 (amps) |
| Heater power = | 400 (watts) |
| Max heater length = | 200 (feet) |
| Heater ohms/k-ft = | 180 (ohms per 1000 feet) |

WIRE LENGTHS (FEET)

| L0 | L1 | L3 | L4 | TOT | OHMS | WATTS | AMPS | AREA |
|---|---|---|---|---|---|---|---|---|
| 100 | 0 | 0 | 0 | 100 | 18.0 | 800 | 6.7 | 25 |
| 100 | 0 | 0 | 13 | 113 | 20.3 | 711 | 5.9 | 28 |
| 100 | 0 | 25 | 0 | 125 | 22.5 | 640 | 5.3 | 31 |
| 100 | 0 | 25 | 13 | 138 | 24.8 | 582 | 4.8 | 34 |
| 100 | 50 | 0 | 0 | 150 | 27.0 | 533 | 4.4 | 38 |
| 100 | 50 | 0 | 13 | 163 | 29.3 | 492 | 4.1 | 41 |
| 100 | 50 | 25 | 0 | 175 | 31.5 | 457 | 3.8 | 44 |
| 100 | 50 | 25 | 13 | 188 | 33.7 | 427 | 3.6 | 47 |

TABLE No. 3

| | |
|---|---|
| Max heated area = | 25 (feet²) |
| Min heated area = | 13 (feet²) |
| Line voltage = | 120 (volts) |
| Line current = | 1.7 (amps) |
| Heater power = | 200 (watts) |
| Max heater length = | 100 (feet) |
| Heater ohms/k-ft = | 720 (ohms per 1000 feet) |

WIRE LENGTHS (FEET)

| L0 | L1 | L3 | L4 | TOT | OHMS | WATTS | AMPS | AREA |
|---|---|---|---|---|---|---|---|---|
| 50 | 0 | 0 | 0 | 50 | 36.0 | 400 | 3.3 | 13 |
| 50 | 0 | 0 | 6 | 56 | 40.5 | 356 | 3.0 | 14 |
| 50 | 0 | 13 | 0 | 63 | 45.0 | 320 | 2.7 | 16 |
| 50 | 0 | 13 | 6 | 69 | 49.5 | 291 | 2.4 | 17 |
| 50 | 25 | 0 | 0 | 75 | 54.0 | 267 | 2.2 | 19 |
| 50 | 25 | 0 | 6 | 81 | 58.5 | 246 | 2.1 | 20 |
| 50 | 25 | 13 | 0 | 88 | 63.0 | 229 | 1.9 | 22 |
| 50 | 25 | 13 | 6 | 94 | 67.5 | 213 | 1.8 | 23 |

The foregoing tables illustrate the connection of certain combinations of lengths of resistive conductors, which are utilized based upon the square footage of the area to be heated. For example, if the area of floor to be heated is 75 square feet then the installation kit, which corresponds to Table 1 would be selected and then within the selected kit a 200 foot and a 100 foot resistive conductor assembly would be chosen and installed, which would provide a potential total of 1,067 watts, of heating capacity. In a like manner if the area to be heated is 23 square feet then a kit, which corresponds to Table 3 would be selected and all four wires would be serially connected by way of butt slices 40 to arrive at a total wire length of 94 feet.

The line current referred to in each table is an average current needed to provide the watts of heater power. The controller alters the duration and/or the amount of current being applied to the resistive conductors. The heater power referred to in each table is the desired heat, which in each table is met by each of the wiring combinations presented therein.

The present invention includes spanning nearly a ten fold difference in floor area with three resistances of wire, with each of the three kits having conductor assemblies 20-28 of four different, binarilly weighted lengths.

The advantages of the invention are economic by reducing the amount of wire necessary to be inventoried and provide kits, with a substantial range of heated floor capacity. Another advantage of the present invention is that in the event one segment of the heater cable is damaged during installation, the damaged piece can be removed making it unnecessary to replace the entire cable in the event of damage.

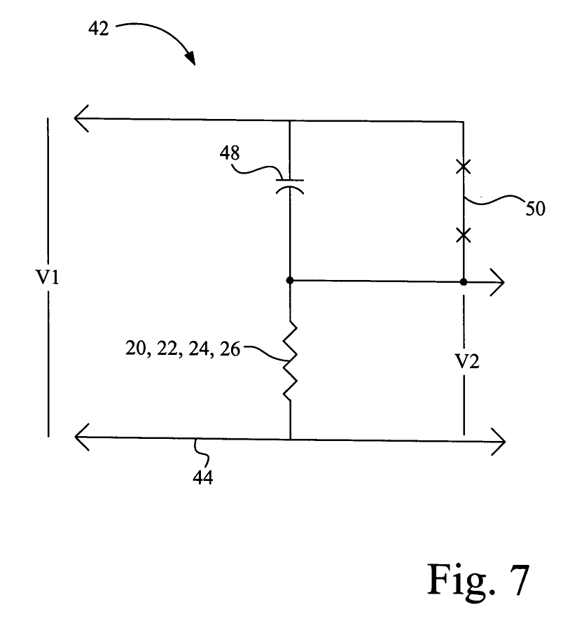

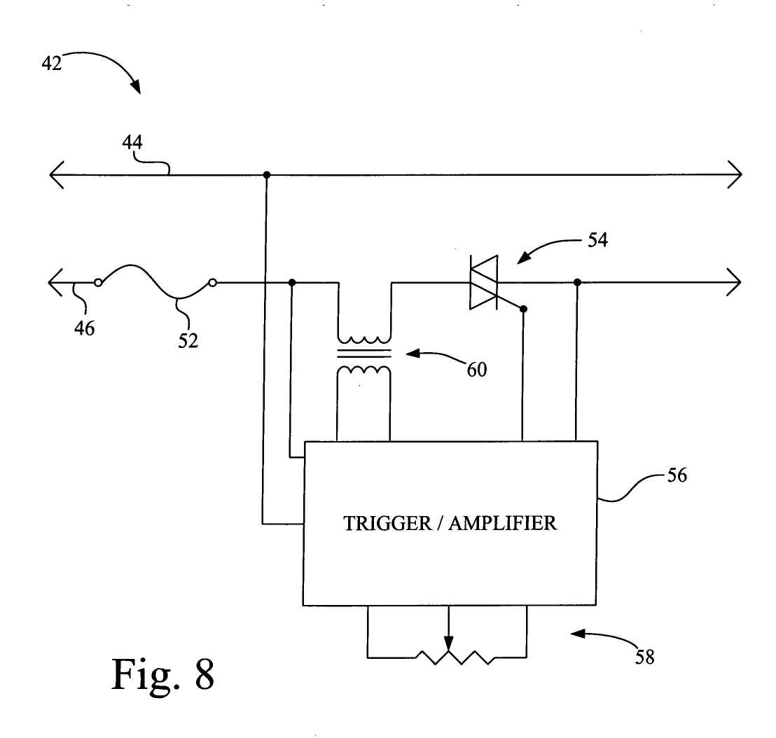

Now, additionally referring to FIGS. 7 and 8 there is shown two embodiments of a power reduction circuit 42. It is to be understood that either of the two power reduction circuits may be incorporated and that they are connected in series to conductors 44 and 46, as shown in FIG. 1.

Referring first to power reduction circuit 42, illustrated in FIG. 7 there is a capacitor 48 and a shunt 50. Capacitor 48 is of a predetermined value and is selected to work with resistive conductor 20, 22, 24 and 26, the combination of resistive conductors being shown schematically in FIG. 7 as a single resistor. Depending on the combination of resistive conductors chosen, shunt 50 may be removed thereby limiting the current applied to the resistive conductors. This allows the heating conductors to operate in a more desirable range based on the combination of the selection of resistive conductors and whether shunt 50 is installed or removed.

Power limiting is desirable so that the resistive conductors are limited to operation of between two and four watts per linear foot. The calculations that follow show the desirability for power limiting along with the two suggested embodiments that accomplish the power limiting result. The power flux, defined as the heater rating in Watts per foot of length, must be limited to a maximum value that can be established during safety testing. For the following example the limit is assumed to be four watts per foot of resistive conductor. This is also expressed as the equation Flux Max=4 watts per foot of resistive conductor.

Based upon experience, the minimum flux should be not less than Flux Min=2 watts per foot of resistive conductor. For purposes of calculation it is assumed that a range of 30 to approximately 60 square feet of floor area will be heated. The maximum floor area is approximately twice the minimum value and use of a binary number relative to the lengths of cables in a installation kit cause the actual maximum area to be:
Max Area=30×(1+0.5+0.25+0.125)=56.25 square feet.

Assume that the heating system operates from 120 volts, which will be represented in the equations by the label Vline. Without power limiting, the maximum power flux occurs at the minimum area and that a minimum power flux occurs at the maximum area. Assume that the minimum flux is two watts per foot and the cable spacing is three inches. This yields a minimum power density of eight watts per square foot.

Calculation of the resistant gradient for the resistive conductors follows:
Minimum power=Max Area×Minimum density=56.25×8=450 watts.
Maximum resistance=Vline²/minimum power=120²/450=32 ohms.
Maximum length of resistive conductor=Minimum power/minimum flux =450 watts/2 watts per foot=225 feet.

The resistive value of the cable then is calculated in ohms per foot, which is:
=Maximum resistance/Maximum length=32 ohms/225 feet=0.14222 Ohms/ft.

Next a calculation of a maximum flux and power is undertaken.
Minimum area=30 square feet of floor area
Minimum length=Minimum area×length of cable per ft²=30×4=120 feet
Minimum resistance=Minimum length×ohms per foot =120 ft×0.14222 Ohms/ft=17.067 Ohms
Maximum power=Vline²/Minimum resistance=120²/17.067 Ohms =843.75 Watts

Now the calculation of the maximum flux and power density is undertaken:
Maximum Flux=Maximum power/Minimum Length=7.0313 watts/ft
Maximum Power Density=Maximum power/Minimum Area=843.75/30 =28.125 Watts/ft²

In this case both the flux and power density considerably exceed the maximum limits, therefore power limiiiting is required.

Utilizing the power limiting of power reduction circuit 42, illustrated in FIG. 7 a series connected resistive conductor and capacitor 48 are connected with shunt 50 removed. Assuming a desired heater flux of 2 watts per foot at the minimum length of 120 feet, the following equation calculates the desired capacitance. The symbol ω is equal to 377, which is equal to the 60 hertz power line frequency in radians per second.
V2=(V1×ω×C×R)/square root (1+ω²×C²×R²)
Where R is the total resistance of the resistive conductors. The power applied to the resistive conductors follows:
Power=Flux×Minimum length, but the resistive conductor power is equal to V2²/R, thereby V2² is equal to P×R and
P×R=V2²=(V1²×ω²×C²×R²)/(1+ω²×C²×R²)
But: P=Flux×Minimum length; and
Flux×Minimum length×R=(V1²×ω²×C²×R²)/(1+ω²×C²×R²)
C=1/(377×Minimum resistance×square root (V²/(Minimum resistance×Minimum length×Flux Min)−1)
C=1/(377×17.067×square root of (120²/(17.067×120×3)−1)
C=134.08 microfarads

Utilizing the above equations results in the following table:

TABLE No. 4

| | |
|---|---|
| Max heated area = | 56 (feet²) |
| Min heated area = | 30 (feet²) |
| Line voltage = | 120 (volts) |
| Max heater length = | 225 (feet) |
| Heater ohms/k-ft = | 142 (ohms per 1000 feet) |

WIRE LENGTHS (FEET)

| | | | | | | | | | W/ |
|---|---|---|---|---|---|---|---|---|---|
| L0 | L1 | L3 | L4 | TOT | OHMS | WATTS | AMPS | AREA | ft |
| 120 | 0 | 0 | 0 | 120 | 17.1 | 329 | 4.4 | 30 | 2.7 |
| 120 | 0 | 0 | 15 | 135 | 19.2 | 335 | 4.2 | 34 | 2.5 |
| 120 | 0 | 30 | 0 | 150 | 21.3 | 337 | 4.0 | 38 | 2.2 |
| 120 | 0 | 30 | 15 | 165 | 23.5 | 614 | 5.1 | 41 | 3.7 |
| 120 | 60 | 0 | 0 | 180 | 25.6 | 563 | 4.7 | 45 | 3.1 |
| 120 | 60 | 0 | 15 | 195 | 27.7 | 519 | 4.3 | 49 | 2.7 |
| 120 | 60 | 30 | 0 | 210 | 29.8 | 482 | 4.0 | 53 | 2.3 |
| 120 | 60 | 30 | 15 | 225 | 32.0 | 450 | 3.7 | 56 | 2.0 |

As can be seen in the foregoing table the first three installations, which utilized wire lengths of up to 150 feet, equivalent to 1.25 times the minimum wire length of 120 feet, utilize the first embodiment of power reduction circuit 42 to reduce the wattage per foot, which is needed due to the wire lengths. Had the first embodiment of power reduction circuit 42 not been utilized, with shunt 50 removed, the power in watts per foot of the first three installations would be respectively, 7.0, 5.6 and 4.5, which is above the desirable maximum of 4.0 watts per foot.

The installation system of the present invention requires the installer to incorporate power reduction circuit 42 and then, based upon the selected number of resistive conductors, which are connected in series, shunt 50 is either installed or removed. Shunt 50 may be in the form of a wire that is cut or removed when called for pursuant to the installation method.

An alternate method of controlling the flux of the resistive conductors is to keep the system current constant independent of the length, using an electronic regulator as shown in FIG. 8. Power reduction circuit 42 of FIG. 8 includes a fuse 52, a semi-conductor switch 54, a control 56, an adjustment 58 and a transformer 60. As 120 volts is applied at V1, fuse 52 will protect the system if the current exceeds the rating of fuse 52. Control 56 operates from the supplied voltage and transformer 60 senses the current flowing through the conductor, which is then measured by a control 56 relative to the adjusted value selected by adjustment 58. The combination of sensed current and adjustment 58 allows control 56 to control semi-conductor switch 54, also known as a TRIAC 54. This advantageously keeps the current going into conductors 44 and 46 at a constant level.

TRIAC 54 can be triggered in at least two different ways. Since both produce the same current flowing through conductors 44 and 46 the choice depends upon cost and power line quality. A first triggering method is a whole cycle switching method. TRIAC 54 is alternately triggered on and off so that the RMS value of the current remains essentially constant when averaged over an extended period of time such as ten seconds. One problem that may be encountered with this method is a tendency to cause light flicker in other circuits attached to the power source. This is particularly evident if fluorescent lamps are in use. A second method is to employ phase triggering. TRIAC 54 starts conducting at some point between the beginning of a half cycle to near its end, thereby providing a smooth control of the current. One potential problem in utilizing this method is the production of a large harmonic content that can result in radio frequency radiation and poor power factor.

Additionally, either power reduction circuit 42 is also controlled by a thermostat, that is not shown, which may utilize temperature sensor 16 for the regulation of the temperature of the heated floor.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A floor heating system, comprising:
a sub-floor;
a plurality of fasteners;
at least one resistive conductor fastened to said sub-floor by way of said plurality of fasteners; and
a capacitor electrically in series with said at least one resistive conductor.

2. The system of claim 1, further comprising a removable shunt connected across said capacitor.

3. The system of claim 1, wherein said at least one resistive conductor includes a first resistive conductor having a first length and a second resistive conductor having a second length, said first length being approximately a first integer multiple of said second length, said first resistive conductor being electrically serially connected to said second resistive conductor.

4. The system of claim 3, wherein said at least one resistive conductor includes a third resistive conductor with a third length, said first length being approximately a second integer multiple of said third length, said third resistive conductor being electrically connected to at least one of said first resistive conductor and said second resistive conductor.

5. The system of claim 4, wherein said at least on resistive conductor includes a fourth resistive conductor with a fourth length, said first length being approximately a third integer multiple of said fourth length, said fourth resistive conductor being electrically connected to at least one of said first resistive conductor, said second resistive conductor and said third resistive conductor.

6. The system of claim 5, wherein said first integer is 2, said second integer is 4, and said third integer is 8.

7. The system of claim 6, further comprising a shunt installed across said capacitor when at least one of said second resistive conductor, said third resistive conductor and said fourth resistive conductor is electrically connected to said first resistive conductor.

8. The system of claim 7, wherein said first resistive conductor, said second resistive conductor, said third resistive conductor and said fourth resistive conductor each have substantially the same resistivity per unit of length.

9. A method of using an electrical heater system kit, the method comprising the steps of:
selecting a plurality of resistive conductors each having the same resistivity and differing lengths, said plurality of resistive conductors including a first resistive conductor;
electrically connecting a capacitor in series with said first resistive conductor; and
placing a removable shunt across said capacitor.

10. The method of claim 9, wherein said plurality of resistive conductors each have a unique length of approximately an integer divisor of said first resistive conductor.

11. The method of claim 10, wherein said plurality of resistive conductors includes a second resistive conductor and a third resistive conductor, said second resistive conductor having a length that is approximately a first integer divisor of said first resistive conductor, said third resistive conductor having a length that is approximately a second integer divisor of said first resistive conductor.

12. The method of claim 11, wherein said first integer is 2 and said second integer is 4.

13. The method of claim 10, further comprising the steps of:
selecting a predetermined set of said plurality of resistive conductors; and
electrically connecting in series said predetermined set of said resistive conductors, said predetermined set of said resistive conductors including said first resistive conductor.

14. The method of claim 13, further comprising the step of removing said shunt across said capacitor when the sum of the lengths of said resistive conductors in said predetermined set are one of equal to and less than approximately a predetermined number times the length of said first resistive conductor.

15. The method of claim 14, wherein said predetermined number is 1.25.

16. A method of installing heater wiring for a floor, comprising the steps of:
obtaining an area dimension of the floor;
selecting a wire resistivity dependent upon said area dimension;
providing a plurality of resistive conductors of said wire resistivity including a first resistive conductor, said plurality of resistive conductors each having a unique length of approximately an integer divisor of said first resistive conductor; and
electrically connecting a capacitor with a shunt across said capacitor to said first resistive conductor.

17. The method of claim 16, further comprising the steps of:
selecting a group of said plurality of resistive conductors; and
electrically connecting said resistive conductors in said group in series, said group including said first resistive conductor.

18. The method of claim 17, further comprising the step of removing said shunt across said capacitor when the sum of the lengths of said resistive conductors in said selected group are one of equal to and less than a predetermined number times the length of said first resistive conductor.

19. The method of claim 18, wherein said predetermined number is approximately 1.25.

20. The method of claim 17, wherein said integer divisors include the numbers of 2, 4 and 8.
